(19) United States
(12) Patent Application Publication
(10) Pub. No.: US 2004/0058226 A1
(43) Pub. Date: Mar. 25, 2004

(54) Efficiency lateral micro fuel cell

(76) Inventors: Philip A. Lamarre, Waltham, MA (US); Robert Scott Morris, Fairhaven, MA (US); Thomas Gennett, Pittsford, NY (US); Ryne Raffaelle, Honeoye Falls, NY (US)

Correspondence Address: Philip Lamarre, 40 Amherst Avenue, Waltham, MA, 02451, US

(21) Appl. No.: 10/419,331

(22) Filed: Apr. 21, 2003

Related U.S. Application Data
(60) Provisional application No. 60/375,057, filed on Apr. 25, 2002.

(51) Int. Cl. H01M 4/86; H01M 8/02; H01M 4/96

(52) U.S. Cl. 429/44; 429/42; 429/38

(57) ABSTRACT

A new type of electrochemical cell is described which can be used for generating electricity, or in an electrolysis mode can produce gases such as hydrogen and oxygen. The cell is constructed from laterally positioned catalyst layers as electrodes with the gap between the catalyst layers having interposed a solid polymer exchange membrane which provides an ion conductive path from the first catalyst layer to the second. The catalyst layers and the electrolyte are in the form of thin films on the surface of a supporting substrate. A plurality of these cells may be formed on the substrate and interconnected electrically forming a network of series and/or parallel connected cells. Means are provided to feed fuel and oxidant to the electrodes as separate gases through channels.

### BACKGROUND OF THE INVENTION

Fuel cells transform chemical energy to electrical energy by reacting gas or liquids in the presence of an electrolyte, electrodes and a catalyst. Previous US patents have described these devices in some detail. Hockaday in U.S. Pat. Nos. 4,673,624, 5,631,099 and 5,759,712 describes methods of forming fuel cells that efficiently use expensive catalysts and are able to be mass-produced. These devices are basically refined miniature versions of the standard “sandwich” fuel cell design where a proton exchange membrane is “sandwiched” between two catalytic electrodes. This design does not easily lend itself to truly inexpensive mass production. Recent advances in electrocatalysts have produced catalysts that work directly and efficiently with alcohol fuels. However, the small size and constricted area of a micro-fuel cell design limits the effectiveness of these catalysts. Therefore, with more active catalysts, there is increased potential power and energy output for the small fuel cell devices. In this regard, novel carbon materials with nanometer dimensions are of potentially significant importance for use as catalysts in micro fuel cells. Incorporation of single walled carbon nanotube (SWCNT) metal supported catalysts in new micro fuel cell designs represents a major improvement in the state of the art in micro fuel cell design. The increased surface area of a nanotube supported platinum catalyst as compared to the typical carbon black electrocatalysts results in higher activity and improved efficiency of the performance of proton exchange membrane, (PEM) and direct methanol (DMFC) fuel cells. Combined with this advance is the use of the lateral micro fuel cell design as the architecture for a SWCNT catalyzed micro fuel. Until now, no one has yet combined these new highly active catalysts with the lateral design. This combination of new catalysts with a new highly efficient fuel cell design forms the basis for the invention. The present invention is an energy and power dense micro fuel cell to micro fuel cell stack that can avoid many of the manufacturing problems inherent in the sandwich design thereby making small, compact fuel cell systems economically feasible.

### SUMMARY OF THE INVENTION

Fuel cells have been designed and built for many years. Most fuel cell designs are what are referred to as “vertical” designs. There is a cathode separated by a membrane and an anode. Some people have used semiconductor manufacturing techniques to make fuel cells but their method has been to simply shrink the “vertical” designs of the past. An example of this method is U.S. Patent Application US 2003/0003347 A1, Pub. Date: Jan. 2, 2003. Using old designs with modem semiconductor manufacturing techniques does not take full advantage of semiconductor techniques. Semiconductor manufacturing is best when applied to “planar technology”.

Only one group to our knowledge approached this idea but did not truly understand its implications, U.S. Pat. No. 4,248,941 talks about putting electrodes “to the side” of each other. However, the patent then describes forming channels “machined into the bottom surface”. It is clear from this statement and others in the patent that the authors do not understand that to take full advantage of semiconductor manufacturing techniques all aspects of the manufacturing should be performed using modem semiconductor techniques. The channels should be formed lithographically and the two parts hybridized using a modem hybridized not “machined into the top surface of the manifold plate”. Also one would not form holes as “Cell fuel exhaust holes drilled through the manifold plate . . . . The three plates are secured together by any suitable means such as bolts or clamps” It is clear from the previous description from patent U.S. Pat. No. 4,248,941 that the authors who are skilled in the art still do not understand the power of semiconductor manufacturing. Holes are not drilled and parts are not clamped and certainly channels are not machined in semiconductor manufacturing. The channels are patterned in a suitable resist structure. The via holes are formed with dry etch techniques and the parts are joined with a standard hybridizer.

Finally no one has described in the patent literature a lateral fuel cell design taking full advantage of semiconductor manufacturing techniques and using nanostructured materials for the electrodes. Nanostructured materials are the final part to this invention, which makes the whole system work at increased efficiencies for a reasonable cost. Simply using semiconductor manufacturing in a lateral design will allow cheap and reliable methods to mass produce fuel cells. However until nanostructured materials are incorporated, the power output is too low to be of commercial use. Combining the idea of lateral design together with nanostructured materials is a novel method that has not been described in the patent literature.

A huge advantage of this method is the ability to incorporate Application Specific Integrated Circuits (ASICs) into the normal fuel cell manufacturing flow. This allows the fuel cell to be “reconfigured” for different voltages. It also allows the fuel cell to “fix” broken cells to continue to deliver voltage even if one cell is damaged. The ASIC incorporated into the lateral design is an invention with large commercial advantages which has not been described in the patent literature.

### BRIEF DESCRIPTION OF DRAWINGS

The different aspects and advantages of this invention will become even more evident through the following description and several embodiments and by referring to the attached drawings, wherein:

FIG. 1 is a schematic cross section of a micro fuel cell made on a substrate according to the present invention.

FIG. 2 is the open circuit voltage of the fuel cell plotted versus time.

FIG. 3 shows several different electrode responses for different configurations.

FIG. 4 is a current density voltage graph

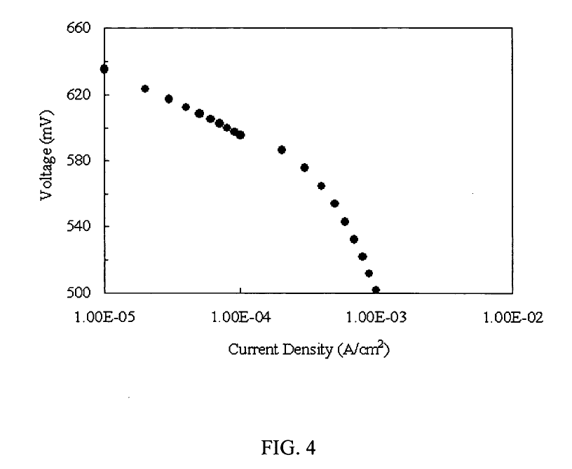

FIG. 5 shows the cross section of a lateral fuel cell

FIG. 6 is an SEM of nanotube growth nucleated on a nanoparticle of metal

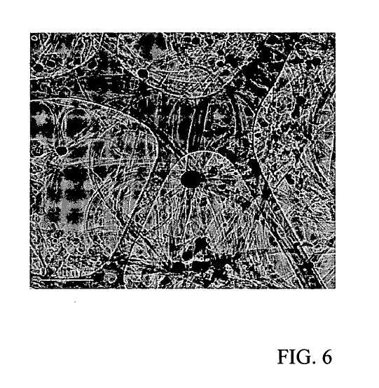

FIG. 7 is an SEM of nanotubes that have been ultrasonically cut

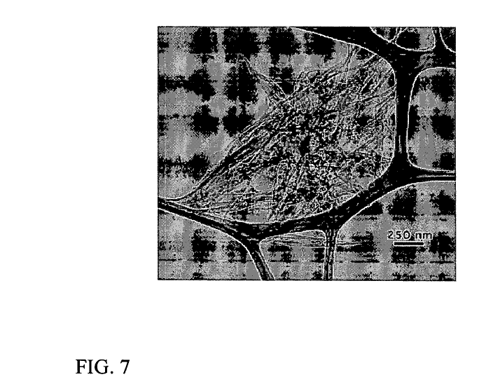

FIG. 8 is a block diagram of a lateral fuel cell integrated with an ASIC

FIG. 9 is a long duration open circuit plot

FIG. 10 shows the comparison between a standard lateral fuel cell and one with nanotubes incorporated

FIG. 11 is one method for delivering hydrogen to a lateral fuel cell

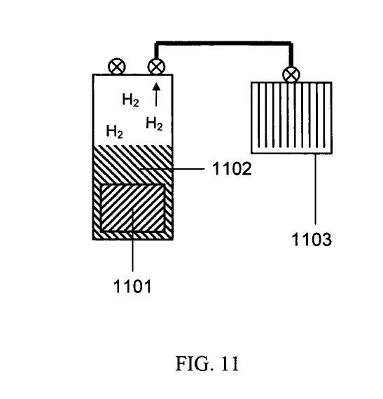

FIG. 12 shows a lateral fuel cell stack with ASCI integration.

### DETAILED DESCRIPTION OF THE PREFERED EMBODIMENTS

The following description is intended as a general description of the invention, these preferred embodiments are used by way of illustration, but not by way of limitation to describe the invention.

The described invention is based on the combination of catalyst supported SWCNTs as the active electrode material within a novel lateral fuel cell architecture.

As the demand for smaller, more efficient power supplies has increased, the interest in regenerative fuel cell systems has once again substantially increased. In many applications it is especially true that greater energy and power demands are placed on the power sources used as the power demands increase with technological complexity. The simultaneous high power and energy requirements of these systems tax the capabilities of even the best conventional electrochemical power supplies. Therefore, small, lightweight and resilient power systems are necessary in order to maximize the technological capabilities of many microsystems.

As the size of fuel cells is decreased it is necessary to enhance the active electrochemical catalyst surface area for the appropriate cell reactions to take place. The catalyst supported-SWCNT composites synthesized by Gennett and Raffaelle have been shown to contain up to a 1000 m²/gram of surface area and metal catalyst nanoparticles with diameters from 2-50 nm. If this increase in surface area was directly translated into a five-fold increase in fuel cell efficiency, devices with performance values of 1500 Whr/kg could be realized. Also, it is expected that, similar to nanofiber materials, the unique atomic structure of the SWCNT supports will influence the catalyst nanomorphology and further improve the catalytic activity of these nanocomposites.

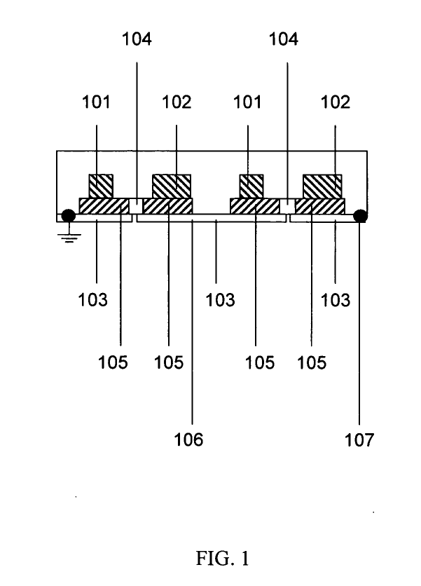

The second part of this invention involves design, fabrication and testing of a novel type of micro fuel cell pioneered by Lamarre and Morris. The basic design is referred to as the Lateral Micro Fuel Cell with the electrodes seated coplanar rather than the traditional sandwich of parallel plates of the Hockaday Micro Fuel Cell mentioned earlier. The Viatronix design is illustrated in FIG. 1. In FIG. 1 the entire micro fuel cell assembly only contains a few process steps and is completely compatible with standard semiconductor manufacturing techniques. The major advantage of the lateral design over the traditional “sandwich” fuel cell configuration is the straightforward manufacture technique. The lateral design fully lends itself to standard semiconductor processing using a variety of substrates including 100-micron Mylar film. As a result, manufacturing costs are minimized and the design eliminates through plane connections. The lateral design produces multi-cell FC planes that can be easily stacked, affords redundancy and on-chip power regulating circuitry. The incorporation of the Mylar film improves the flexibility and durability of the design.

Finally, since the lateral micropower fuel cell assembly process is compatible with standard silicon manufacturing technology, an Application Specific Integrated Circuit (ASIC) Fuel Cell Power Stack (FCPS) is possible. The ASIC-FCPS would be a “smart” power supply that could sense the device and power load into which it was inserted and reconfigure its voltage and current output instantaneously to match the requirements of the new device. This ability to swap power sources rapidly and without concern for having the “correct” voltage and current would be helpful to engineers fabricating satellites and to soldiers in combat. Another extremely useful characteristic of an ASICFCPS would be reliability. In the event that a portion of the micro fuel cell stack was disabled, the smart stack would sense which cells were damaged and reconfigure the remaining working fuel cells to bring the voltage and current back to the required levels.

Lateral Fuel Cell

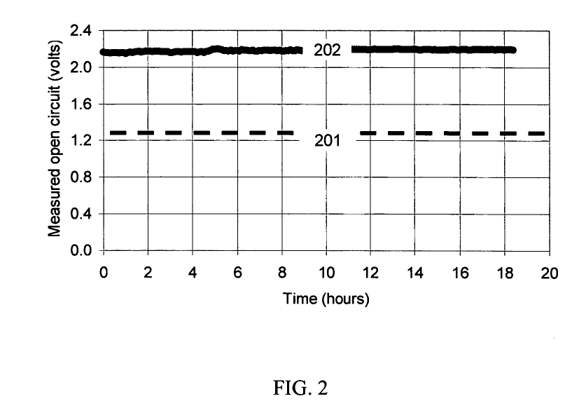

Placing the electrodes side by side is conceptually different from all other micro fuel cells. All other workers stack the electrodes, which is a simple reduction in size of a standard fuel cell. Placing the electrodes side by side allows the power of semiconductor manufacturing techniques to be used for this application. Semiconductor manufacturing involves lithographic patterning of electrodes, dry etching of micro gas feeds and the like. This general concept is illustrated in the schematic cross section FIG. 1. In FIG. 1 the hydrogen feed is numbered 101. the oxygen feed is 102 and 104 is the polymer exchange membrane. The platinum nanoparticles and nanotubes are 105 and the thin film platinum is 103. this figure also demonstrates how the later design can increase voltage lithographically. All steps use semiconductor techniques and the voltage can be increased. In FIG. 1 the output voltage is in excess of 1.2 volts. The measured voltage of a lithographically produced lateral fuel cell is shown in FIG. 2. In FIG. 2 the output voltage is well in excess of 1.2 volts for a “lithographically stacked” cell.

Manufacturing

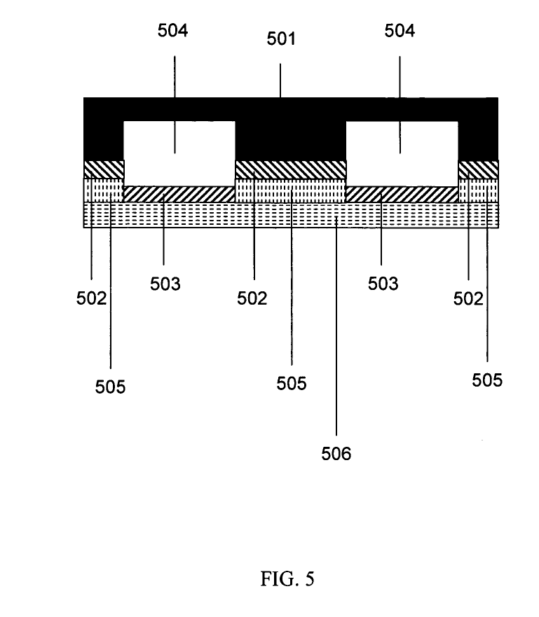

FIG. 5 shows the details of one possible method to manufacture the lateral fuel cell. 501 is the microchannel plate which is formed by lithography using a thick photo sensitive resist such as SU-8. The same channels can be made by etching into silicon or glass. 504 are the channels which carry the fuel and oxidizer. 502 is a rubber based resist which seals the channel plate. the polymer exchange membrane (PEM) is 505. A polymer matrix holds the nanotubes nucleated onto metal nanoparticles is disposed onto a thin film of platinum 503.

SWCNT Catalysts

Raw SWCNT soots have been generated with a variety of metal catalysts including Ni, Co, Pd, Rh and Pt with various combinations of just Pt and Ru for DMFC applications.^{mrs reference} Experimentally, it is possible control diameter and helicity distributions of the produced nanotubes through a combination of catalyst type, reactor temperature, laser wavelength, raster rate and laser power density. These parameters can also be used to control the size of the condensed metal particles. The laboratory production rates, which are dependent on experimental conditions, range from 10-300 mg/hr. The purity of tubes within the raw soot can be as high as 50% w/w and as low as 1% w/w, depending on experimental needs.

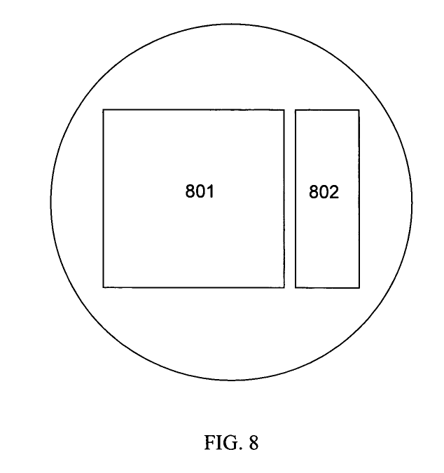

Recently Gennett et al, have demonstrated a straightforward 3-step purification process which results in materials which are >98 wt % pure, (Patent applied for by Gennett, Dillon and Heben in 2000). FIG. 8 displays transmission electron microscopy images of laser-generated material containing SWCNTs nucleated on Pt.

Independent BET measurements have shown these materials have a surface area up to 1000 m²/g. From syntheses that utilize the higher refractory catalyst metals (Pt, Pd, Rh), the resultant material contains the metal catalyst supporting the nanotube superstructure, as shown in FIG. 8.

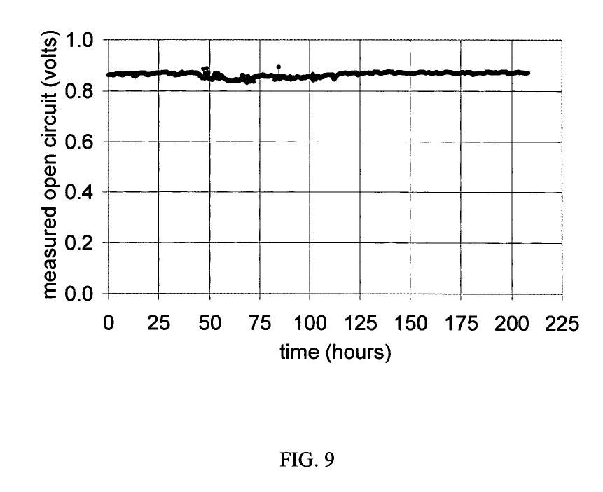

In the laser synthesis of SWCNTs, a high dispersion of platinum nanoparticles can be achieved within the nanotube matrix. A high dispersion of metal catalyst particles has been shown to give rise to electrocatalytic activity with other carbon materials including: carbon black, carbon fibers and ordered nanoporous carbon. However, the advantage to nanotubes is quite unique; freestanding films can be made without a need for a silica template, the nanotube/metal catalysts can be dispersed in several different polymer materials, and individual SWCNTs can be dispersed and mechanically aligned in the composite films. Finally, since the nanotubes can be ultrasonically cut into finite lengths of approximately 1 micron (see FIG. 9), the dispersion of the “cut’ tubes and nanocrystalline catalysts into the PEM matrix may be enhanced through chemical interactions of the polymer with the functionalized materials.

Application of the Catalysts to the Fuel Cell

Application of the SWCNTs to the electrodes of the lateral fuel cell design can be accomplished by a number of different means. The following application process descriptions are given to illustrate the concept, but are not meant to be limiting.

In the first example, with and without platinum catalyzed SWCNTs are first ultrasonically dispersed in a 5% Nafion (DuPont Chemical Co.) solution (Aldrich Chemical Co.). This matrix is then spin coated onto the lateral FC pattern after carefully masking the ion channels between the electrodes using standard photolighographic techniques. The catalyst-coated electrodes are then masked with a metal mask and the ion channels are subjected to ultraviolet illumination to weaken the photoresist covering the ion channels. This ion channel photoresist is then removed by aqueous acid developing exposing the ion channels of the substrate. These channels are then filled with Nafion by spin coating another layer of Nafion solution over the masked fuel cell.

As an alternative approach, the aforementioned Nafion/SWCNT nafion solution is spin coated onto the fuel cell. The ion channels are then exposed by selectively dry etching the ion channels using standard semiconductor manufacturing tools, such as Inductively Coupled Plasma (ICP) dry etching. The ion channels are then filled with Nafion by spin coating a film of Nafion over the entire fuel cell. A microwriting system (such as the Ohmcraft Micropen) can also be used to direct write various channels of the nafion nanotube composite and PEM separator directly onto the chip surface.

By way of illustration, but not by way of limitation, the following example of the invention is presented.

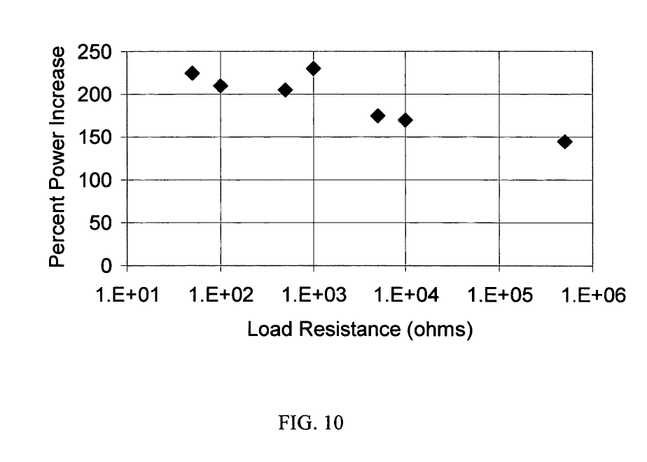

In this experiment, a standard smooth platinum lateral fuel cell design was tested in comparison to the same design in which SWCNTs were applied to the electrodes of a second fuel cell using the spin coat technique previously described. The two fuel cells were run using the hydrogen/air combination. Performance curves were generated using precision resistors as the load. The full cell voltage of the two fuel cells was measured using a precision programmable digital volt meter connected to a data logger. The resistive load on the fuel cell was held for 5 minutes to clearly establish the full cell voltage of the test device under the stated load. The performance of the two fuel cells was then compared as shown in FIG. 10.

As can be seen, incorporating NON-PURE platinum nanotubes into a prototype lateral fuel cell increases the power output of the micro fuel cell from 140 to over 220 percent depending on the load resistor. This is significant because the prototype lateral fuel cell was not optimized to take advantage of the full catalytic activity of the platinized SWCNTs. Optimizing and purifying the nanotubes should increase power significantly.

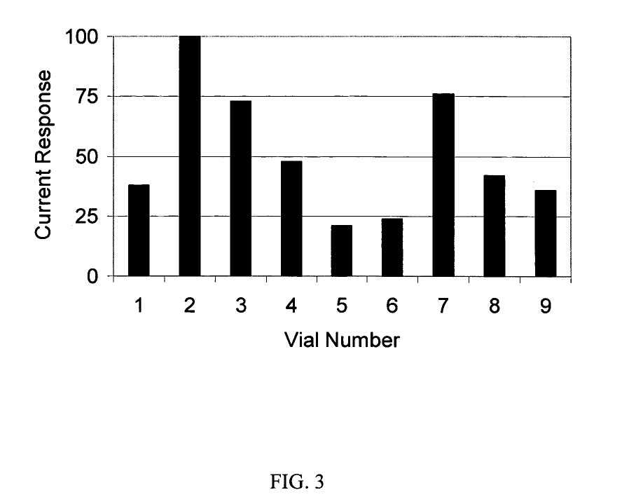

The increase in raw power of a fuel cell incorporating carbon nanotubes is not surprising as basic electrochemistry predicts these results. FIG. 3 shows many different electrochemistry experiments comparing electrochemistry of cells containing nanotubes and without. Vile 5 contained no nanotubes whereas Vial 2 contained nanotubes. the difference is obvious. Cells containing nanotubes showed 2 to 5 times the electrochemical activity compared to cells which did not contain tubes.

Smart Battery Option

FIG. 8 shows a potential advantage to the lateral fuel cell proposed in this disclosure. Since all manufacturing steps are compatible with standard semiconductor manufacturing, it is possible to make integrated circuits at the same time and on the same substrate as the lateral fuel cell. These integrated circuits could be Application Specific Integrated Circuits (ASICs). These circuits could use diodes and transistors to control the flow of current such that voltages could be changed in response to many factors. As an example, if a cell were damaged during use, the integrated circuit could reconfigure the running fuel cell to circumvent the damaged cell and continue to deliver the required power to the running application. Also, the integrated circuit could be configured so that when the lateral fuel cell was attached to an application, the fuel cell could sense the application, configure the fuel cell accordingly and deliver the required voltage and current for the needed application. This and other “intelligent” functions could be performed by the fuel cell and integrated circuit. Using the integrated circuit in combination with the fuel cell on the same substrate is called the “smart battery option”.

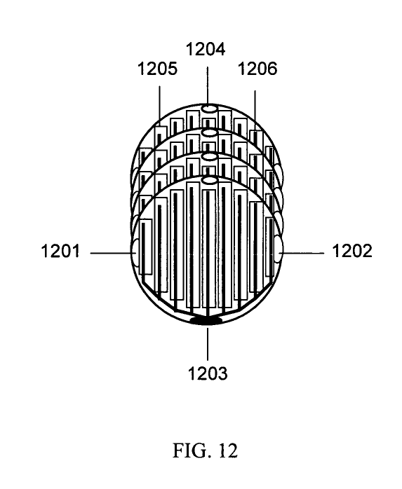

FIG. 12 shows a stack of lateral fuel cells to increase power. 1201 is the side bus to connect all the voltages together. 1202 is the side to connect the ground bus. 1203 is where the fuel is connected. 1204 is an light emitting diode which is integrated into the manufacturing process for this particular configuration. This is one possible configuration many more configurations are possible changes.

Membraneless Microchannel Fuel Cell

The benefits of single wall carbon nanotubes also applies to membraneless microchannel fuel cells. In a membraneless microchannel fuel cell due to laminar flow there is minimal intermixing of the fluids so no PEM is needed. Single Wall Carbon Nanotubes (SWCNs) are included as thin films on the anode and cathode. Nanotubes while significantly increasing surface area do not significantly change geometry and thus disturb laminar flow. This addition to a microfluidic PEM-less fuel cell would significantly increase power for this methodology. This plan while demonstrated using simple fuels of methanol and oxygen dissolved in water could also be extended to other fuels such as vanadium, etc.

That which is claimed is:

1. A fuel cell composed of a half-cell comprising a nanoporous catalytic electrode permeable to a fuel gas and connected through parts of the half-cell to an electric load circuit, a negative half-cell comprising a nanoporous catalytic electrode permeable to an oxygen containing gas and its products of the electrodic reaction and connectable through parts of the half-cell to said electrical load circuit of the cell, a cation exchange membrane separating said electrodes, means for deeding said fuel gas to said catalytic electrode of the positive cell and means for feeding oxygen containing gas to said catalytic electrode of the negative half-cell and for exhausting products of the electric reaction, characterized in that each half-cell is formed on a suitable substrate. The substrate could be either semi-insulating silicon or glass or a thin film of Mylar or other suitable material. The mention cell may be controlled by an application integrated specific circuit which is formed at the same time using compatible methods to control said cell and configure electronically said cell.

2. The cell of claim one is characterized in that each half-cell nanoporous material is composed of single wall carbon nanotubes or alternatively single wall carbon nanotubes nucleated on nanoparticles of platinum or alternatively single wall carbon nanotubes nucleated on platinum ruthenium nanoparticles or other metal or non-metal particles.

3. The electrodic thin film material of claim one is platinum metal, platinum ruthenium metal or other suitable metallic material.

4. The application integrated specific circuit means for controlling said cell in claim 1 is to control voltage and or current and or reliability of said cell.

5. The means for delivering fuel and oxygen to the two half-cells are formed through photolithography in thick photoresist type materials or alternately the pattern is formed in photoresist type materials and the pattern is wet or dry etched into the substrate.

6. The method for forming the electrodic thin film material in claim 3 is either through thin film deposition and liftoff or through thin film deposition and etch back.

7. The means for delivering fuel and oxygen described in claim 5 is sealed to the substrate material through hot isostatic pressing or through hot isostatic pressing with a thin film of rubber based photoresist disposed onto the channel plate to form a hermetic seal.

8. As in claim 2, where the carbon nanotubes are synthesized by any of the current processes (Laser, Arc, CVD) or any future process.

9. As in claim 8, except to include any as-produced or processed or purified carbon nanotube materials.

10. As in claim 2, to include the use of other carbon nanotubes materials in the basic fuel cell design described.

11. As in claim 10, to include any carbon nanotube materials with post synthesis incorporation of catalyst materials by various chemical and mechanical processes.

12. As in claim 1 for the incorporation or use of the design or specific materials in any type of fuel cell design, including but not limited to PEM, hydrogen, direct methanol, . . .

13. As in claim 1, whereby the electrodes and cell design are constructed on the substrate using lithographic, microwriting or other microprocessing technique.

14. The benefits of single wall carbon nanotubes also applies to membraneless microchannel fuel cells.
